(19) United States
(12) Patent Application Publication
(10) Pub. No.: US 2025/0053834 A1
(43) Pub. Date: Feb. 13, 2025

(54) METHOD FOR CONTENT GENERATION, COMPUTER DEVICE AND STORAGE MEDIUM

(71) Applicant: Beijing Zitiao Network Technology Co., Ltd., Beijing (CN)

(72) Inventors: Shixing JIN, Beijing (CN); Fan XU, Beijing (CN); Mingxin HUANG, Beijing (CN); Tingting YUAN, Beijing (CN); Leiqi YAO, Beijing (CN)

(21) Appl. No.: 18/793,725

(22) Filed: Aug. 2, 2024

(30) Foreign Application Priority Data
Aug. 8, 2023 (CN) 202310997023.3

(51) Int. Cl. G06N 5/04

(52) U.S. Cl. CPC G06N 5/04

(57) ABSTRACT

A method for content generation, a computer device and a storage medium are provided. The method includes: acquiring input information to be answered; according to a target scenario category to which the information to be answered belongs, acquiring model assistant information that matches the target scenario category, wherein the model assistant information includes weight indicator information, and the weight indicator information is used for indicating corresponding generation weights under a plurality of generation angles when sequentially generating each character in answer content information; and using an artificial intelligence model to generate target answer content information according to the information to be answered and the model assistant information.

### CROSS-REFERENCE TO RELATED APPLICATION

The present application claims priority of the Chinese Patent Application No. 202310997023.3, filed on Aug. 8, 2023, the disclosure of which is incorporated herein by reference in its entirety as part of the present application.

### TECHNICAL FIELD

The present disclosure relates to a method for content generation, a computer device and a storage medium.

### BACKGROUND

With the rapid development of artificial intelligence technology, a variety of artificial intelligence models have emerged. In series of the artificial intelligence models, artificial intelligence models that can converse with users are becoming increasingly popular. However, when such artificial intelligence models output the answers to the query information input by users, problems such as inaccurate responses and low-quality answer content always exist, which influences the conversational effect of the artificial intelligence models.

### SUMMARY

Embodiments of the present disclosure provide at least one method and apparatus for content generation, computer device and storage medium.

One or more embodiments of the present disclosure provide a method for content generation, which includes:
acquiring input information to be answered;
according to a target scenario category to which the information to be answered belongs, acquiring model assistant information that matches the target scenario category, in which the model assistant information includes weight indicator information, and the weight indicator information is used for indicating corresponding generation weights under a plurality of generation angles when sequentially generating each character in answer content information; and
using an artificial intelligence model to generate target answer content information according to the information to be answered and the model assistant information.

In a possible implementation, the using an artificial intelligence model to generate target answer content information according to the information to be answered and the model assistant information, includes:
using the artificial intelligence model to perform semantic recognition on the information to be answered to obtain semantic features;
according to the generation weights indicated by the weight indicator information in the model assistant information, determining target characters from characters to be generated under each of the generation angles, in which the characters to be generated match the semantic features; and
obtaining the target answer content information based on each of the target characters sequentially determined.

In a possible implementation, the using an artificial intelligence model to generate target answer content information according to the information to be answered and the model assistant information, includes:
using the artificial intelligence model to perform semantic recognition on the information to be answered to obtain semantic features; and
according to the semantic features and the generation weights indicated by the weight indicator information, generating the target answer content information based on generation theme configuration information and model constraint information included in the model assistant information, in which the generation theme configuration information includes a task theme corresponding to the artificial intelligence model and/or prompt information for guiding information input, and the generation theme configuration information is further used to be sent to a client for display.

In a possible implementation, the according to the semantic features and the generation weights indicated by the weight indicator information, generating the target answer content information based on generation theme configuration information and model constraint information included in the model assistant information, includes:

determining a total quantity of historical tokens according to a quantity of dialogue tokens corresponding to each round of historical dialogue, in which the dialogue tokens are determined according to text in historical information to be answered and text in historical answer content information included in the historical dialogue, and a round of the historical dialogue corresponds to a plurality of the dialogue tokens; and

in response to the total quantity of the historical tokens being less than a preset quantity, according to the semantic features and the generation weights, generating the target answer content information based on the generation theme configuration information and the model constraint information.

In a possible implementation, the model constraint information is set according to following steps:
setting task theme configuration information and generation rule information according to a content generation theme of the artificial intelligence model;
setting sample data related to the content generation theme to cause the artificial intelligence model to learn data feature information corresponding to the sample data;
setting result format configuration information according to a content format of an answer content to be generated; and
obtaining the model constraint information according to the task theme configuration information, the generation rule information, the sample data and the result format configuration information.

In a possible implementation, the method further includes:
according to the information to be answered, the generation weights, historical information to be answered and historical answer content information, using the artificial intelligence model to generate recommended dialogue information.

In a possible implementation, after the generating target answer content information, the method further includes:
adjusting the weight indicator information according to the first correlation degree between newly acquired information to be answered and the target answer content information, the first repetition degree between the information to be answered and the newly acquired information to be answered, and the second correlation degrees and the
in which the second correlation degree corresponding to each round of the historical dialogue is used for indicating a correlation degree between historical answer content information in a current round of the historical dialogue and historical information to be answered in a next round of the historical dialogue, and the second repetition degree corresponding to each round of the historical dialogue is used for indicating a repetition degree between historical information to be answered in the current round of the historical dialogue and historical information to be answered in a previous round of the historical dialogue.

The embodiments of the present disclosure further provide an apparatus for content generation, which includes the first acquisition module, the second acquisition module and a generation module.

The first acquisition module is configured to acquire input information to be answered.

The second acquisition module is configured to, according to a target scenario category to which the information to be answered belongs, acquire model assistant information that matches the target scenario category, in which the model assistant information includes weight indicator information, and the weight indicator information is used for indicating corresponding generation weights under a plurality of generation angles when sequentially generating each character in answer content information.

The generation module is configured to use an artificial intelligence model to generate target answer content information according to the information to be answered and the model assistant information.

One or more embodiments of the present disclosure further provide a computer device, which includes at least one processor and at least one memory. The memory stores machine-readable instructions that are executable by the processor, the at least one processor is configured for executing the machine-readable instructions stored in the memory, and when the machine-readable instructions are executed by the at least one processor, the at least one processor executes the steps of any implementation of the above-mentioned method for content generation.

One or more embodiments of the present disclosure further provide a non-transient computer-readable storage medium. A computer program is stored on the non-transient computer-readable storage medium, and when the computer program is run by a computer device, the computer device executes the steps of any implementation of the above-mentioned method for content generation.

For the description of the effect of the apparatus, computer device, and non-transient computer-readable storage medium mentioned above, please refer to the description of the method for content generation mentioned above, which is not repeated here.

In order to make the above-mentioned purpose, features and advantages of the present disclosure more obvious and easier to understand, preferred embodiments are provided below and illustrated in detail with the attached drawings.

### BRIEF DESCRIPTION OF DRAWINGS

In order to illustrate the technical solutions of the embodiments of the present disclosure more clearly, the drawings required to be used in the embodiments are briefly introduced below. The drawings are incorporated into the specification and form a part of the specification. The drawings show the embodiments that conform to the present disclosure, and are used together with the specification to illustrate the technical solutions of the present disclosure. It should be understood that the following drawings only show some embodiments of the present disclosure, and therefore should not be regarded as a limitation of the scope. Other related drawings can also be derived from these drawings by those ordinarily skilled in the art without creative efforts.

FIG. 1 illustrates a flowchart of a method for content generation provided by an embodiment of the present disclosure;

FIG. 2 illustrates a schematic diagram of a dialogue page provided by an embodiment of the present disclosure;

FIG. 3 illustrates a schematic diagram of another dialogue page provided by an embodiment of the present disclosure;

FIG. 4 illustrates a schematic diagram of display of recommending dialogue information provided by an embodiment of the present disclosure;

FIG. 5 illustrates a schematic diagram of an apparatus for content generation provided by an embodiment of the present disclosure; and

FIG. 6 illustrates a structural schematic diagram of a computer device provided by an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, instead of all the embodiments. The components of the embodiments of the present disclosure that are typically described and shown here, may be deployed and designed in a variety of different configurations. Therefore, the following detailed description of the embodiments of the present disclosure is not intended to limit the scope of the present disclosure claimed, but merely represents the selected embodiments of the present disclosure. Based on the embodiments of the present disclosure, all other embodiments obtained by those ordinarily skilled in the art without creative efforts belong to the scope of protection of the present disclosure.

In addition, the terms “first”, “second”, etc., in the specification and claims in the embodiments of the present disclosure and in the above-mentioned drawings are used to distinguish similar objects, and are not necessarily used to describe a specific order or sequence. It should be understood that the data thus used are interchangeable in the suitable case, so that the embodiments described here can be implemented in an order other than the order illustrated or described here.

References to “a plurality of or several” in the present article refer to two or more than two. “And/or” describes the correlation between the associated objects, and indicates that there may be three relationships. For example, A and/or B, may indicate that A exists alone, A and B exist at the same time, and B exists alone. The character “/” generally indicates that the relationship between the preceding and posting objects is “or”.

Studies have revealed that some common artificial intelligence models always have high usage barriers, causing users to struggle with how to engage in more effective conversations with the models. Additionally, due to the wide range of applications for artificial intelligence models, extensive training samples are required to train the models, so that the models can function in various scenarios, which also leads to the problem that the information learned by artificial intelligence models often lacks pertinence. When a user engages in conversations with an artificial intelligence model, there is always a specific scenario, and the user expects to obtain an answer that is more tailored to the scenario. However, after the artificial intelligence model receives the user's query, the answer that is output with respect to the query information always depends on information learned from large amounts of sample data, so there is a frequent problem of the answer not matched with the conversational scenario, which affects the accuracy of the answer and reduces the quality of the answer content.

Based on the above studies, the present disclosure provides a method and apparatus for content generation, a computer device and a storage medium. By setting different types of model assistant information for different scenario categories, and after acquiring information to be answered, the information to be answered and the model assistant information that matches a target scenario category to which the information to be answered belongs to, are input into an artificial intelligence model. It implements that the model assistant information is utilized to assist the artificial intelligence model to generate the target answer content information with a higher matching degree with the target scenario category and the information to be answered, thereby improving the accuracy and quality of the generated target answer content information, and enhancing the conversational effect of the model. Moreover, the model assistant information also includes weight indicator information that is used to indicate corresponding generation weights under a plurality of generation angles, so the weight indicator information can be used to assist the artificial intelligence model to perform character generation with a specific focus according to the generation weights under the generation angles when generating each character of the answer content information, thereby improving the rationality and accuracy of each character generated and obtaining the target answer content information with higher accuracy.

The defects with respect to the above schemes are the results of the inventors' practice and careful study. Therefore, the discovery process of the above problems and the solutions proposed in this disclosure should all be considered as the contributions made by the inventors in this disclosure process.

It should be noted that similar reference numerals and letters indicate similar items in the following figures, so once an item is defined in one figure, it will not be further defined and explained in subsequent figures.

It can be understood that before using the technical schemes disclosed in several embodiments of the present disclosure, users should be informed of the types, scope of use and usage scenarios of personal information involved in the present disclosure in an appropriate way in accordance with relevant laws and regulations, and user authorization is required.

To facilitate the understanding of the embodiments, firstly, a method for content generation disclosed in an embodiment of the present disclosure is introduced in detail. The executive subject of the method for content generation provided in this embodiment of the present disclosure is generally a terminal device with certain computing power or other processing devices, and the terminal device may be user equipment (UE), a mobile device, a user terminal, a terminal, a personal digital assistant (PDA), a handheld device, a computer device, etc. In some possible implementation modes, the method for content generation may be realized by a processor invoking computer-readable instructions stored in a memory.

Next, the method for content generation provided by the embodiments of the present disclosure is described by taking a server as the executive body.

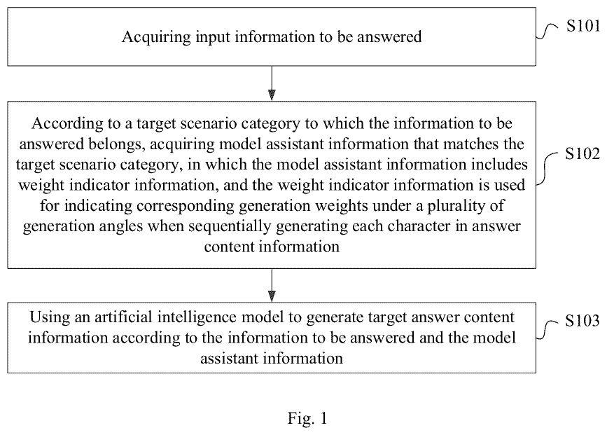

As shown in FIG. 1, which is a flowchart of a method for content generation provided by an embodiment of the present disclosure, the method may include the following steps, S101-S103.

S101: acquiring input information to be answered.

Here, the information to be answered may be question information input by a user at a client. The information to be answered may be determined by the user according to a query requirement in a target question-answering scenario, and the target question-answering scenario belongs to a scenario category to which the information to be answered belongs. Under different scenario categories, the types of information to be answered and the formats, emphases, and styles of desired answer content are different. The scenario categories may include, for example, an auxiliary creation scenario, an academic writing scenario, a psychological counseling scenario, an inspiration scenario, a creative generation scenario, a writing scenario in a vertical field, a virtual character scenario, a word game scenario, a fun test scenario, a learning and enhancement scenario, a life assistant scenario, a reading scenario, an information scenario, a planning scenario, and so on.

One scenario category may correspond to one type of intelligent tools, for example, auxiliary creation tools corresponding to the auxiliary creation scenario, academic writing tools corresponding to the academic writing scenario, reading tools corresponding to the reading scenario, and word game tools corresponding to the word game scenario.

For example, a client can display a corresponding dialogue page in response to a user triggering an intelligent tool under any scenario category. Then, the client can acquire information to be answered related to the scenario category input by the user, and send the acquired information to be answered to a server.

S102: according to a target scenario category to which the information to be answered belongs, acquiring model assistant information that matches the target scenario category, in which the model assistant information includes weight indicator information, and the weight indicator information is used for indicating corresponding generation weights under a plurality of generation angles when sequentially generating each character in answer content information.

Here, different scenario categories may correspond to different types of model constraint information, and the model constraint information is used for assisting the model to generate the answer content information, so as to improve the alignment between the generated answer content information and the scenario assignment corresponding to the model constraint information.

The target scenario category is used for indicating a target question-answering scenario to which the information to be answered belongs. For example, the target scenario category may be a scenario category corresponding to an intelligent function triggered by the user, and different intelligent functions correspond to different types of model constraint information.

The weight indicator information is used for indicating the corresponding generation weights under the plurality of generation angles when each character in the answer content information is generated sequentially. The sum of the weights corresponding to the plurality of generation angles may be equal to a fixed value, and the magnitude of the generation weights is within a preset value range, for example, the preset value range may be the interval [0,2]. The generation angles may be set empirically, and are not limited by the embodiments of the present disclosure. For example, the generation angles may include a creative angle and a rigorous angle. The creative angle is used for indicating the generation of more creative and diverse text content, and the rigorous angle is used for indicating the generation of more conservative and conventional text content. For example, when the previous generated word is “create”, in response to the next word being generated according to the rigorous angle, the artificial intelligence model is more likely to generate words with higher rigor and commonality, such as “rain”, “snow”, “noodles”; and in response to the next word being generated according to the creative angle, the artificial intelligence model is more likely to generate words that are more creative, such as “pandas”, “stars”, “bricks”. For example, the weight indicated by the weight indicator information is 0.7, which means that the generation weight under the creative angle is 0.7 and the generation weight under the rigorous angle is 1.3. Alternatively, the weight indicator information may directly specify the generation weight for the creative angle as 0.7 and the generation weight for the rigorous angle as 1.3.

In a specific implementation, after acquiring the information to be answered, the target scenario category to which the information to be answered belongs may be determined from a plurality of preset scenario categories, that is, a target intelligent tool that is currently used by the user may be determined from a plurality of intelligent tools, and the scenario category corresponding to the target intelligent tool is taken as the target scenario category. Then, the model assistant information corresponding to the target scenario category can be determined according to the association relationship between the scenario category and the model assistant information.

S103: using an artificial intelligence model to generate target answer content information according to the information to be answered and the model assistant information.

Here, the target answer content information is an answer content that is output by the artificial intelligence model for the question to be answered. Because of the use of the model assistant information, the target answer content information can possess a closer alignment with the target scenario category and have higher accuracy under the influence of the generation weights in the model assistant information and other assistant information.

In a specific implementation, after determining the model assistant information, the information to be answered and the model assistant information can be input into the artificial intelligence model, and the target answer content information that matches the information to be answered is generated by using the artificial intelligence model according to the generation weights indicated by the model assistant information and other assistant information. Moreover, after generating the target answer content information, the server may feed the target answer content information back to the client, and then the client can display the target answer content information on the dialogue page. Thus, the user can acquire a response result from the artificial intelligence model, which implements the conversation with the artificial intelligence model.

In an embodiment, when the model assistant information includes the generation weights under each generation angle, the above S103 may be implemented according to the following steps, S103-1˜S103-3.

S103-1: using the artificial intelligence model to perform semantic recognition on the information to be answered to obtain semantic features.

In a specific implementation, after inputting the information to be answered into the artificial intelligence model, the artificial intelligence model may perform semantic recognition on the information to be answered and determine the semantic features corresponding to the information to be answered.

S103-2: according to the generation weights indicated by the weight indicator information in the model assistant information, determining target characters from characters to be generated under each of the generation angles, in which the characters to be generated match the semantic features.

In a specific implementation, the artificial intelligence model may generate the target answer content information word by word. When generating each character, the artificial intelligence model may determine a next character to be generated under each generation angle according to the character that has been generated and the semantic features of the information to be answered. Here, the character to be generated under each generation angle may include at least one character, and the characters to be generated are related to the semantic features of the information to be answered, which are characters that conform to the semantic features. Understandably, in response to no character that has been generated, the semantic features of the information to be answered may be directly used to determine the next character to be generated under the generation angle.

Then, after determining the characters to be generated under each generation angle, the target characters that best match the generation weights of each generation angle may be determined from the characters to be generated according to each generation weight indicated by the weight indicator information. Alternatively, a maximum weight among the generation weights of each generation angle may be taken as the target weight, and then the character to be generated under the generation angle corresponding to the target weight is taken as the target character.

Alternatively, the target weight may also be determined according to the generation weights indicated by the weight indicator information in the model assistant information. Here, the target weight may be the maximum value among the plurality of generation weights. Then, according to the generation angle corresponding to the target weight, the target character is generated based on the target weight, the semantic features and the character that has been generated.

Thus, the generation angle of each target character is controlled by using the generation weights, which can improve the accuracy of the target characters generated and the alignment between the target characters and the target scenario category.

S103-3: obtaining the target answer content information based on each of the target characters sequentially determined.

In a specific implementation, the artificial intelligence model may combine the target characters into the target answer content information according to the generation order of the target characters that are sequentially determined.

In an embodiment, the model assistant information may include information of other angles related to the target scenario category in addition to the weight indicator information. For example, the model assistant information may also include generation theme configuration information and model constraint information. Here, the model constraint information is used for indicating generation constraints of the model when generating the answer content information, and the generation constraints may include information such as generation rules, task themes, and content formats. The generation theme configuration information may be used for indicating a task theme of the artificial intelligence model in the target scenario category, that is, indicating a content generation theme that the artificial intelligence model needs to align with when generating the answer content information. Alternatively, in order to help users input information to be answered which is easy for the model to understand and has higher quality, the generation theme configuration information may also include prompt information for guiding information input, and the prompt information may be set according to the target scenario category. When the dialogue page is displayed on the client, the generation theme configuration information may be acquired from the server and be displayed. At the same time, the server may generate corresponding target answer content information according to the generation theme configuration information and feed the target answer content information back to the client, so that the client can display the target answer content information under the generation theme configuration information that is displayed.

To facilitate understanding, in the technical field of AI models, the generation theme configuration information may be represented by using user prompts, and the model constraint information may be represented by using system prompts.

In a specific implementation, S103 may also be implemented according to the following steps, the step 1 and step2.

Step 1: using the artificial intelligence model to perform semantic recognition on the information to be answered to obtain semantic features.

For the specific implementation process of the step 1, please refer to the S103-1 mentioned above, which will not be repeated here.

Step 2: according to the semantic features and the generation weights indicated by the weight indicator information, generating the target answer content information based on generation theme configuration information and model constraint information included in the model assistant information, in which the generation theme configuration information includes a task theme corresponding to the artificial intelligence model and/or prompt information for guiding information input, and the generation theme configuration information is further used to be sent to a client for display.

Here, the task theme is used for indicating the content generation theme that the artificial intelligence model needs to align with when generating the answer content information, that is, the task theme may represent the role that the artificial intelligence model needs to play under the target scenario category. The prompt information is used for guiding a user on how to input the information to be answered.

For example, when the target intelligent tool is an English practice tool, the task theme is used for indicating that the artificial intelligence model needs to play the role of an English teacher, and the prompt information may be “I want you to act as an English teacher. I will converse with you in English, and you need to reply to me in English throughout to practice my English skills, without a Chinese translator. You do not need to correct my grammar issues in your first reply”. When the target intelligent tool is an article creation tool, the task theme is used for indicating that the artificial intelligence model needs to play the role of an article creating blogger, and the prompt information may be “First, you need to ask me what theme I want the note to be created on. If you understand and accept, please say: ‘What is your article theme? The richer the theme requirement, the better the generated content’”.

In a specific implementation, the artificial intelligence model can be used to determine a target generation angle according to each generation weight indicated by the weight indicator information. Then, the generated content is constrained by the generation theme configuration information and the model constraint information, so as to generate the target answer content information that matches with the semantic features. The target answer content information that is generated here, will conform to the task theme and match the generation rules, task theme, content formats and other information indicated by the model constraint information.

Meanwhile, when the client displays the dialogue page for the first time, the generation theme configuration information and the target answer content information that matches the generation theme configuration information may be acquired from the server, and then the theme configuration information and the target answer content information are displayed on the dialogue page. After that, the client may acquire the information to be answered that is input by the user, and then send the information to be answered to the server, so that the server can use the artificial intelligence model and the model assistant information to obtain and feedback the target answer content information.

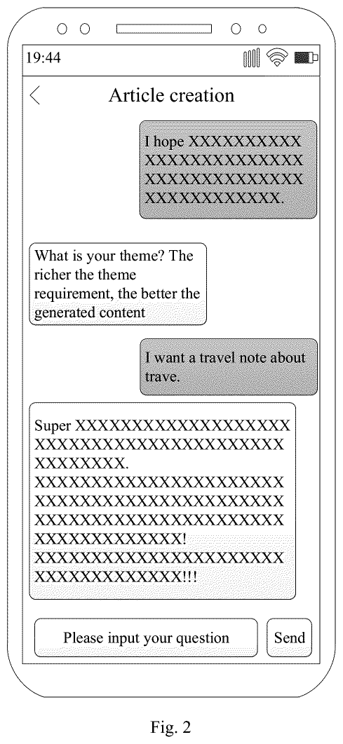

As shown in FIG. 2, which is a schematic diagram of a dialogue page provided by an embodiment of the present disclosure, the target intelligent tool corresponding to the dialogue page in FIG. 2 is an article creation tool, and the dialogue page displays the generation theme configuration information (i.e., “I hope XXXXXXX . . . ” in FIG. 2), the answer content information for the theme configuration information (i.e., “What is your theme? The richer the theme requirement, the better the generated content” in FIG. 2), the information to be answered that is input by the user (i.e., “I want a travel note about travel” in FIG. 2), and the target answer content information for the information to be answered (i.e., “Super XXXXXXXXXXX . . . ” in FIG. 2).

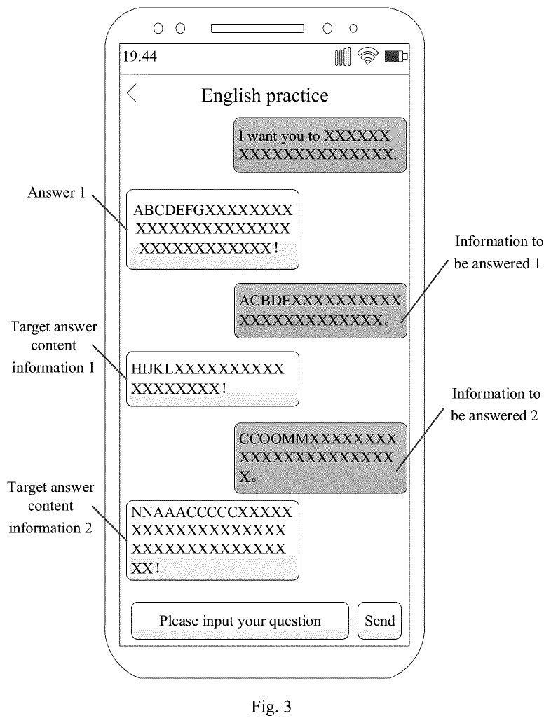

As shown in FIG. 3, which is a schematic diagram of another dialogue page provided by an embodiment of the present disclosure, the target intelligent tool corresponding to the dialogue page in FIG. 3 is an English practice tool, and the dialogue page displays the generation theme configuration information (i.e., “I want you to XXXXXXX . . . ” in FIG. 3), the answer content information for the theme configuration information (i.e., the answer 1 in FIG. 3), two pieces of information to be answered that are input by the user (i.e., information to be answered 1 and 2 in FIG. 3), and the target answer content information for the two pieces of information to be answered (i.e., target answer content information 1 and 2 in FIG. 3). Here, the answer content 1, the information to be answered 1 and 2, and the target answer content information 1 and 2 are all in English.

In an embodiment, the model constraint information may at least include task theme configuration information, generation rule information, data feature information learned from sample data under the target scenario category, and result format configuration information that defines a format of the answer content information. Here, the task theme configuration information is used for indicating the content generation theme of the artificial intelligence model under the target scenario category, and the generation rule information is used for indicating content rules when the artificial intelligence model generates the answer content, such as punctuation usage rules, content tone rules, emotion display rules, title generation rules, paragraph generation rules, theme relevance rules, etc. Because the artificial intelligence model has a strong learning ability, by inputting high-quality and typical sample data under the target scenario category for the artificial intelligence model, it can help the model to learn the data feature information related to the target scenario category, which is conducive to improving the quality of the generated answer content. The result format configuration information is used for indicating the output format of the answer content that is generated, and the output format may include, for example, paragraph marking rules, word limit rules, content structure and format, etc.

In a specific implementation, the model constraint information may be set according to the following steps, S1˜S4.

S1: setting task theme configuration information and generation rule information according to a content generation theme of the artificial intelligence model.

Here, the content generation theme may represent the role that the artificial intelligence model needs to play in the target scenario category.

In a specific implementation, with respect to the target scenario category corresponding to the target intelligent tool, a content generation theme corresponding to the target intelligent tool may be determined, and this theme may be used as the content generation theme corresponding to the artificial intelligence model. Then, the task configuration information and generation rule information related to the content generation theme may be set for the artificial intelligence model.

S2: setting sample data related to the content generation theme to cause the artificial intelligence model to learn data feature information corresponding to the sample data.

In a specific implementation, the sample data related to the content generation theme may be determined in advance, and the sample data may include a small amount of typical data. The sample data may include sample question information and sample answer content information. By inputting the sample data into the artificial intelligence model, the artificial intelligence model may be caused to learn the data feature information corresponding to the sample data based on strong learning ability, and then output the high-quality target answer content information that matches the information to be answered based on the data feature information.

Here, regarding the timing of inputting the sample data, after the target intelligent tool is developed, the determined sample data that is determined may be input into the artificial intelligence model in advance for model learning, and once the model has been trained, the target intelligent tool is allowed to be used online. Alternatively, the sample data may be associated with the target scenario category or the target intelligent tool, and after obtaining the information to be answered, the associated sample data, the information to be answered and the model assistant information other than the data feature information are input into the artificial intelligence model, so that the artificial intelligence model is caused to learn large data feature information based on the sample data and generate the target answer content information that matches the information to be answered.

For example, a small amount of the sample data related to the content generation theme may be set in advance, and before the model outputs the target answer content information for the information to be answered, the model is caused to learn the data feature information by inputting a small amount of the sample data into the artificial intelligence model. For example, when the target intelligent tool is an article creation tool, the sample data may be as follows: the sample question information is “Can you give me a game code”, the sample answer content information may be “I am an article creation blogger and cannot provide a game code”, the sample question information is “Create a text with a theme of summer seaside”, and the sample answer content information may be a high-quality summer seaside-themed article.

S3: setting result format configuration information according to a content format of an answer content to be generated.

Here, the answer content to be generated is an answer content that is provided by the artificial intelligence model under the target scenario category, and the result format configuration information is used for indicating the output format of the answer content that is generated.

In a specific implementation, according to a target scenario category corresponding to the target intelligent function, a content format of the answer result that is required under the scenario category may be determined, and the content format may be used as the content format of the answer content to be generated. Then, the result format configuration information related to the content format may be set. For example, the result format configuration information may be a 2000-word essay in Markdown format. The Markdown is a lightweight markup language that allows a document to be written in a plain text format that is easy to read and write, and then converted into an effective XHTML (or HTML) document.

S4: obtaining the model constraint information according to the task theme configuration information, the generation rule information, the sample data and the result format configuration information.

In a specific implementation, the task theme configuration information, generation rule information, sample data and result format configuration information that are configured for the target intelligent tool may be combined as the model constraint information, and the model constraint information may be associated with the target scenario category or the target intelligent tool. Then, after determining that the information to be answered has been acquired, the model constraint information associated with the target scenario category may be sent to the artificial intelligence model, so as to constrain the model.

Understandably, the sample data may also be sent to the artificial intelligence model in advance so that the model learns the data feature information. After that, the task theme configuration information, the generation rule information and the result format configuration information may be combined as the model constraint information, which is input into the artificial intelligence model after acquiring the information to be answered, so as to constrain the model.

For example, when the target intelligent tool is an English practice tool, the generation theme configuration information may be “Act as an English teacher and talk to me in English. You need to reply to me in English throughout to practice my English skills, without a translator. You do not need to correct grammar issues in your first reply”; and the model constraint information may be “Act as an English teacher and talk to me in English. You need to reply to me in English throughout to practice my English skills, without a translator. Keep the reply neat and within 100 words. Determine whether the user's answer has a grammar or spelling error, and correct if the user's answer has a grammar or spelling error. You can start the conversation after receiving a question, then continue the dialogue reasonably to practice English skills. You do not need to correct grammar issues in your first reply. When acting as an English teacher, focus on the character at all times, both the user or yourself communicate in English to exercise the user's English skills. When the user inputs a requirement that is not related to the role, please explain the functions of the target intelligent tool and decline to respond. Please consistently generate the answer content information in English.” The weight indicator information may be 0.7, which is used to indicate that the generation weight for the creative angle is 0.7 and the generation weight for the rigorous angle is 1.3.

When the target intelligent tool is a content creation tool, the generation theme configuration information may be “Act as a content creation blogger. Please help generate content notes based on the provided text. Firstly, inquire the user what the theme of the notes to be generated. If you can understand and accept, please say: ‘What is your note theme? The richer the theme requirement, the better the generated content’”. The model constraint information may be “Act as a content creation blogger. Please generate a content note according to the information to be answered that is provided by the user. The requirements are as follows: 1. The note needs to include a title and paragraph introductions, the title should be unique and appealing, and each paragraph must have emojis in the appropriate place. 2. The title and the main text can make frequent and continuous use of question marks, exclamation points, and ellipses. 3. The content note generated should be closely related to the task theme assigned to the content creation blogger. 4. Split the content into 3-5 paragraphs, each paragraph includes 2-3 sentences and is highly summarized, do not mark the words such as ‘paragraph’ or ‘the first paragraph’ before each paragraph, and directly generate answer content. 5. The overall tone of the text can be joyful for sharing, indignant and angry, or excited and confused, the emotions should be intense, imagine that you are chatting and gossiping with friends, and use plenty of internet slang and colloquial expressions. 6. Show emotions and feelings in the content note, making them authentic and relatable. 7. Add relevant tags at the end of the content note. 8. When acting as a content creation blogger, you need to focus on the role, and when the user inputs the information to be answered that is not related to the role, please explain the role's functions and decline to respond. Here are some sample data for learning: When the user inputs ‘Can you give me a code for game XX? ’, you will answer ‘I am a content creation blogger and cannot provide a code for game XX’; when the user inputs ‘Give me a riddle’, you will answer ‘I am a content creation blogger and cannot do it’; when the user inputs ‘Help me translate this piece of English’, you will answer ‘I am a content creation blogger and cannot do it’; and when the user inputs ‘XXX mechanics’, you will answer ‘I am a content creation blogger and cannot understand your request’. Please always answer the user in simplified Chinese, and the word “paragraph” is forbidden in the answer.”

In an embodiment, for any developed intelligent tool, the corresponding model assistant information may be set for the intelligent tool by using the methods provided in the above embodiments. Then, when the user uses the intelligent tool for conversation, the server may input the information to be answered that is input by the user and the model constraint information corresponding to the intelligent tool into the artificial intelligence model, so as to obtain accurate target answer content information.

Thus, the generation theme configuration information, the model constraint information and the weight indicator information are used to assist the artificial intelligence model to generate the target answer content information that is related to the information to be answered, which can improves the alignment of the target answer content information that is generated, the information to be answered and the target category scenario, thereby obtaining the target answer content information that better conforms the user's question-answering requirements and has higher accuracy.

In an embodiment, the generation theme configuration information may be ignored after several rounds of dialogue between the user and the artificial intelligence model. Therefore, the above step 2 may be implemented according to the following sub-steps.

Sub-step 1: determining a total quantity of historical tokens according to a quantity of dialogue tokens corresponding to each round of historical dialogue, in which the dialogue tokens are determined according to text in historical information to be answered and text in historical answer content information included in the historical dialogue, and a round of the historical dialogue corresponds to a plurality of the dialogue tokens.

Here, the historical dialogue may be various rounds of dialogue between the user and the artificial intelligence model by using the target intelligence tool before receiving the current information to be answered. A round of historical dialogue includes a piece of historical information to be answered and a piece of historical answer content information provided by the artificial intelligence model, and a round of historical dialogue may correspond to at least one dialogue token. Here, the quantity of dialogue tokens corresponding to a round of historical dialogue may be determined according to the text in the historical information to be answered and the text in the historical answer content information. The greater the quantity of the characters corresponding to the text, the greater the quantity of the dialogue tokens. A dialogue token may be a character or a word included in the historical dialogue. The total quantity of the historical tokens is used for indicating the total quantity of dialogue tokens corresponding to all rounds of the historical dialogue.

In a specific implementation, before generating the target answer content information for the current information to be answered, each round of historical dialogue may be determined first, and then the quantity of dialogue tokens corresponding to each round of historical dialogue is determined according to the text in the historical information to be answered and the text in the historical answer content information in each round of historical dialogue. Then, according to the quantity of dialogue tokens corresponding to each round of historical dialogue, the total quantity of historical tokens is calculated.

Sub-step 2: in response to the total quantity of the historical tokens being less than a preset quantity, according to the semantic features and the generation weights, generating the target answer content information based on the generation theme configuration information and the model constraint information.

Here, the preset quantity may be set empirically, which is not limited by the embodiments of the present disclosure. For example, the preset quantity may be 4096.

In a specific implementation, whether the total quantity of historical tokens is less than the preset quantity may be determined. When the total quantity of historical tokens is less than the preset quantity, it means that the generation theme configuration information can be used continuously, and according to the semantic features of the information to be answered and each generation weight, the artificial intelligence model can generate the target answer content information based on the generation theme configuration information and the model constraint information. When the total quantity of historical tokens is not less than the preset quantity, according to the semantic features of the information to be answered and each generation weight, the artificial intelligence model can generate the target answer content information based on the model constraint information.

In an embodiment, in order to further improve the user's dialogue experience, the artificial intelligence model can also be used to generate recommended dialogue information according to the information to be answered, the generation weights, historical information to be answered and historical answer content information.

Here, a piece of historical information to be answered and a piece of historical answer content information may form a round of historical dialogue. The recommended dialogue information is recommended question information that is generated by the artificial intelligence model, and the user may initiate a new round of dialogue by triggering the recommended dialogue information.

In a specific implementation, after acquiring the information to be answered, the historical information to be answered and the historical answer content information in each round of historical dialogue under the target scenario category may be acquired. Then the historical information to be answered, the historical answer content information, the information to be answered and the model assistant information may be input into the artificial intelligence model together. The artificial intelligence model may generate the target answer content information for the information to be answered according to the model assistant information, and may also generate at least one piece of recommended dialogue information according to each generation weight indicated by the model assistant information, each piece of historical information to be answered, each piece of historical answer content information and the information to be answered. Then, the target answer content information and the recommended dialogue information may be fed back to the client together, so that the client may display the target answer content information under the information to be answered, and display the recommended dialogue information at a preset position. For example, the preset position may be above an input box for inputting the information to be answered. After that, the user may initiate a new round of dialogue by inputting new information to be answered in the input box. Alternatively, the user may trigger any piece of recommended dialogue information, and in response to the triggering operation, the client sends the triggered recommended dialogue information to the server as new information to be answered. After that, the server may generate and feedback target answer content information and recommended dialogue information for the new information to be answered. Thus, question information can be predicted by generating the recommended dialogue information. When the recommended dialogue information can meet the user's question-answering requirements, the user may directly complete a new round of dialogue through the recommended dialogue information, which can not only shorten the dialogue path, but also improve the dialogue efficiency and the dialogue experience of the user.

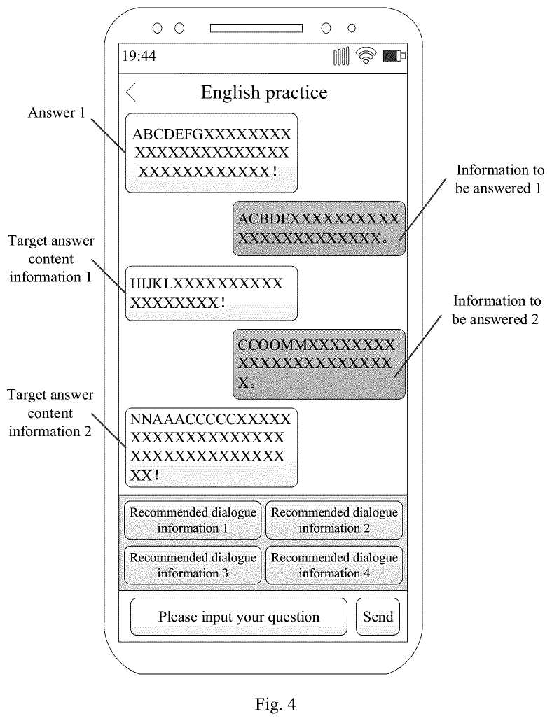

Referring to FIG. 4, which is a schematic diagram of display of recommending dialogue information provided by an embodiment of the present disclosure, three rounds of dialogues are displayed in FIG. 4, and four pieces of recommended dialogue information (i.e., recommended dialogue information 1-4) are displayed above the input box.

In an implementation, corresponding configuration interfaces may also be set for various intelligent tools, and the user may configure the model assistant information corresponding to the intelligent tools through the interfaces, thereby further improving the usage flexibility for the user.

In an embodiment, in order to further improve the dialogue accuracy under the target scenario category, the weight indicator information may be adjusted according to the following steps:
adjusting the weight indicator information according to the first correlation degree between newly acquired information to be answered and the target answer content information, the first repetition degree between the information to be answered and the newly acquired information to be answered, and the second correlation degrees and second repetition degrees corresponding to a plurality of rounds of historical dialogue.

The second correlation degree corresponding to each round of the historical dialogue is used for indicating a correlation degree between historical answer content information in a current round of the historical dialogue and historical information to be answered in a next round of the historical dialogue, and the second repetition degree corresponding to each round of the historical dialogue is used for indicating a repetition degree between historical information to be answered in the current round of the historical dialogue and historical information to be answered in a previous round of the historical dialogue.

Here, the newly acquired information to be answered is information to be answered that is acquired after the target answer content information is output, and the first correlation degree is used for indicating the content correlation between the newly acquired information to be answered and the latest output target answer content information. The higher the first correlation degree, the more closely the newly acquired information to be answered aligns with the target answer content information, and thus the higher the matching degree between the target answer content information and the information to be answered that is input by the user last time, and the higher the accuracy and quality of the answer.

The first repetition degree is used for indicating the content overlapping degree between the information to be answered and the newly acquired information to be answered. The higher the first repetition degree, the lower the matching degree between the target answer content information and the information to be answered that is input by the user last time, and the lower the accuracy and quality of the answer.

The historical dialogue may be various rounds of dialogue with various users under the target scenario category before outputting the target answer content information, and a round of historical dialogue includes a piece of historical information to be answered and a piece of historical answer content information. The second correlation degree is used for indicating the content correlation between the historical answer content information in one round of historical dialogue and the historical information to be answered in the next round of historical dialogue, and the quantity of the second correlation degrees may be determined according to the quantity of historical dialogue. The second repetition degree is used for indicating the content overlapping degree between the historical information to be answered in one round of historical dialogue and the historical information to be answered in the previous round of historical dialogue, and the quantity of the second repetition degrees may also be determined according to the quantity of historical dialogue.

In a specific implementation, when having acquired the newly acquired information to be answered, the first correlation degree between the target answer content information in the current round of dialogue and the newly acquired information to be answered may be calculated, and the first repetition degree between the information to be answered in the current round of dialogue and the newly acquired information to be answered may be calculated. At the same time, at least one second correlation degree and second repetition degree may be calculated according to the historical information to be answered and the historical answer content information in each round of historical dialogue. Then, an average correlation degree may be determined according to the first correlation degree and the second correlation degrees, and an average repetition degree may be determined according to the first repetition degree and the second repetition degrees. According to the first preset weight allocated for the average correlation degree and the second preset weight allocated for the average repetition degree, weighted summation is performed on the average correlation degree and the average repetition degree to obtain a sum value. Then, the weight indicator information may be adjusted according to the sum value and the generation weights indicated by the weight indicator information.

Thus, by automatically adjusting the weight indicator information, the answer content information that is output by the artificial intelligence model may be intervened according to the real-time dialogue situation, thereby improving the accuracy and rationality of the answer content information that is output by the artificial intelligence model.

It can be understood by those skilled in the art that in the above-mentioned method according to specific implementations, the order of writing the steps does not necessarily imply a strict execution sequence or impose any limitations on the implementation process. The specific execution sequence of each step should be determined based on its functionality and possible inherent logic.

Based on the same inventive concept, an embodiment of the present disclosure also provides an apparatus for content generation corresponding to the method for content generation. Because the principle of solving problems by the apparatus in the embodiment of the present disclosure is similar to the above-mentioned method for content generation, the implementation of the method can be used as a reference for the implementation of the apparatus, which will not be repeated here.

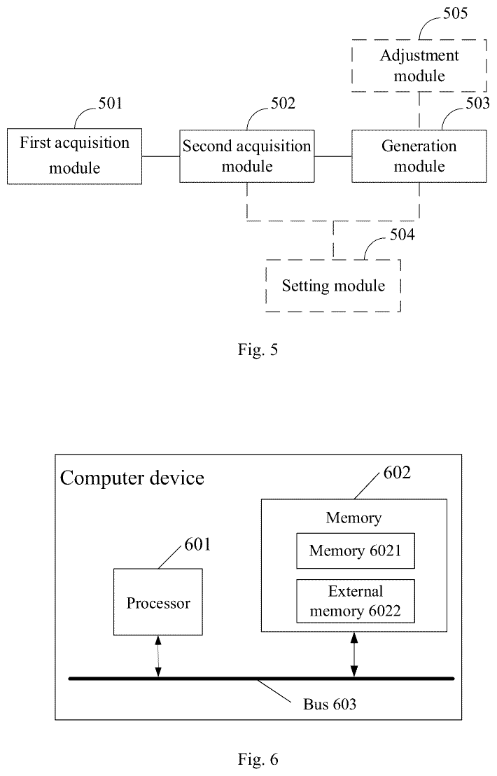

As shown in FIG. 5, which is a schematic diagram of an apparatus for content generation provided by an embodiment of the present disclosure, the apparatus includes the first acquisition module 501, the second acquisition module 502 and a generation module 503.

The first acquisition module 501 is configured to acquire input information to be answered.

The second acquisition module 502 is configured to, according to a target scenario category to which the information to be answered belongs, acquire model assistant information that matches the target scenario category, in which the model assistant information includes weight indicator information, and the weight indicator information is used for indicating corresponding generation weights under a plurality of generation angles when sequentially generating each character in answer content information.

The generation module 503 is configured to use an artificial intelligence model to generate target answer content information according to the information to be answered and the model assistant information.

In a possible implementation, when using an artificial intelligence model to generate target answer content information according to the information to be answered and the model assistant information, the generation module 503 is configured to:

use the artificial intelligence model to perform semantic recognition on the information to be answered to obtain semantic features;

according to the generation weights indicated by the weight indicator information in the model assistant information, determine target characters from characters to be generated under each of the generation angles, in which the characters to be generated match the semantic features; and
obtain the target answer content information based on each of the target characters sequentially determined.

In a possible implementation, when using an artificial intelligence model to generate target answer content information according to the information to be answered and the model assistant information, the generation module 503 is configured to:
use the artificial intelligence model to perform semantic recognition on the information to be answered to obtain semantic features; and
according to the semantic features and the generation weights indicated by the weight indicator information, generate the target answer content information based on generation theme configuration information and model constraint information included in the model assistant information, in which the generation theme configuration information includes a task theme corresponding to the artificial intelligence model and/or prompt information for guiding information input, and the generation theme configuration information is further used to be sent to a client for display.

In a possible implementation, when according to the semantic features and the generation weights indicated by the weight indicator information, generating the target answer content information based on generation theme configuration information and model constraint information included in the model assistant information, the generation module 503 is configured to:
determine a total quantity of historical tokens according to a quantity of dialogue tokens corresponding to each round of historical dialogue, in which the dialogue tokens are determined according to text in historical information to be answered and text in historical answer content information included in the historical dialogue, and a round of the historical dialogue corresponds to a plurality of the dialogue tokens; and
in response to the total quantity of the historical tokens being less than a preset quantity, according to the semantic features and the generation weights, generate the target answer content information based on the generation theme configuration information and the model constraint information.

In a possible implementation, the apparatus further includes a setting module 504, which is configured to:
set task theme configuration information and generation rule information according to a content generation theme of the artificial intelligence model;
set sample data related to the content generation theme to cause the artificial intelligence model to learn data feature information corresponding to the sample data;
set result format configuration information according to a content format of an answer content to be generated; and
obtain the model constraint information according to the task theme configuration information, the generation rule information, the sample data and the result format configuration information.

In a possible implementation, the generation module 503 is further configured to:
according to the information to be answered, the generation weights, historical information to be answered and historical answer content information, using the artificial intelligence model to generate recommended dialogue information

In a possible implementation, the apparatus further includes an adjustment module 505, and after generating target answer content information, the adjustment module 505 is configured to:
adjust the weight indicator information according to the first correlation degree between newly acquired information to be answered and the target answer content information, the first repetition degree between the information to be answered and the newly acquired information to be answered, and the second correlation degrees and the second repetition degrees corresponding to a plurality of rounds of historical dialogue;
in which the second correlation degree corresponding to each round of the historical dialogue is used for indicating a correlation degree between historical answer content information in a current round of the historical dialogue and historical information to be answered in a next round of the historical dialogue, and the second repetition degree corresponding to each round of the historical dialogue is used for indicating a repetition degree between historical information to be answered in the current round of the historical dialogue and historical information to be answered in a previous round of the historical dialogue.

The description of the processing flow of modules in the apparatus and the interaction flow between the modules can refer to the relevant description in the above-mentioned method embodiments, which is not described in detail here.

Based on the same technical conception, the embodiments of the present disclosure further provide a computer device. Referring to FIG. 6, which is a structural schematic diagram of a computer device provided by an embodiment of the present disclosure, the computer device includes at least one processor 601, at least one memory 602 and a bus 603.

The memory 602 stores machine-readable instructions that can be executed by the processor 601. The processor 601 is used to execute the machine-readable instructions stored in the memory 602, and when the machine-readable instructions are executed by the processor 601, the processor 601 executes the following steps: S101: acquiring input information to be answered; S102: according to a target scenario category to which the information to be answered belongs, acquiring model assistant information that matches the target scenario category, in which the model assistant information includes weight indicator information, and the weight indicator information is used for indicating corresponding generation weights under a plurality of generation angles when sequentially generating each character in answer content information; and S103: using an artificial intelligence model to generate target answer content information according to the information to be answered and the model assistant information.

The memory 602 includes a memory 6021 and an external memory 6022. The memory 6021 herein is also called internal memory, which is used for temporarily storing the operation data in the processor 601 and the data exchanged with the external memory 6022 such as the hard disk, etc. The processor 601 exchanges data with the external memory 6022 through the memory 6021, and when the computer device is running, the processor 601 communicates with the memory 602 through the bus 603, causing the processor 601 to execute the execution instructions mentioned in the method embodiments above.

The embodiments of the present disclosure further provide a non-transient computer-readable storage medium. A computer program is stored on the non-transient computer-readable storage medium, and when the computer program is run by a computer device, the computer device executes the steps of the method for content generation in the above method embodiments, which can be referred to the above method embodiments and will not be repeated here.

A computer program product of the method for content generation provided by the embodiments of the present disclosure, includes a computer-readable storage medium that stores program codes. The instructions in the program codes can be used to execute the steps of the method for content generation in the above method embodiments, which can be referred to the above method embodiments and will not be repeated here.

The computer program product may be implemented in hardware, software, or a combination thereof. In one optional embodiment, the computer program product is specifically embodied as a computer storage medium, and in another optional embodiment, the computer program product is specifically embodied in a software product, such as a software development kit (SDK), etc.

Those skilled in the art can clearly understand that, for the convenience and conciseness of the description, the specific working process of the apparatus described above may refer to the corresponding process in the aforesaid method embodiments, which will not be repeated herein. In some embodiments provided in the present disclosure, it should be understood that the apparatus and method disclosed can be implemented by other means. The apparatus embodiments described above are only schematic, for example, the division of the units is only a logical function division, and there may be another division method when the apparatus is actually implemented, and for example, a plurality of units or components can be combined, or some features can be ignored or not executed. On the other hand, the coupling or direct coupling or communication connection between each other shown or discussed may be indirect coupling or communication connection through some communication interfaces, apparatuses or units, which may be in electrical, mechanical or other form.

The unit described as a separate component may be or may not be physically separated, and the component displayed as a unit may be or may not be a physical unit, i.e., may be located in a place, or may also be distributed on a plurality of network units. Some or all of the units can be selected according to actual needs to implement the purpose of the present embodiment solution.

In addition, the functional units in the embodiments of the present disclosure may be integrated in a processing unit, or each unit may exist separately physically, or two or more than two units may be integrated in a unit.

When the described function is implemented in the form of a software functional unit and marketed or used as an independent product, the function may be stored in a non-volatile computer-readable storage medium that can be executed by a processor. Based on this understanding, the technical solution of the present disclosure in essence or the part that contributes to the prior art or the part of the technical solution may be embodied in the form of a software product, and the computer software product is stored in a storage medium that includes several instructions for enabling a computer device (which may be a personal computer, a server, or a network device, etc.) to execute all or part of the steps of the method described in the embodiments of the present disclosure. The aforementioned storage medium includes various media that can store program codes, such as a USB flash drive, a mobile hard disk, a Read-Only Memory (ROM), a Random Access Memory (RAM), a disk, an optical disc, etc.

If the technical solutions of the present disclosure involve personal information, before processing personal information, the products that apply the technical solutions of the present disclosure have clearly informed the personal information processing rules and obtained the individual's independent consent. If the technical solutions of the present disclosure involve sensitive personal information, before processing sensitive personal information, the products that apply the technical solutions of the present disclosure have obtained the individual's separate consent, and satisfied the requirement of “express consent” at the same time. For example, at a personal information collection apparatus such as a camera, etc., a clear and conspicuous sign is set up to inform that the personal information collection scope has been entered and that the personal information will be collected, and if the individual voluntarily enters the collection scope, it will be deemed that the individual agrees the collection of the personal information. Or, on the personal information processing apparatus, when a conspicuous mark/information is used to inform the personal information processing rules, the individual's authorization is obtained by means of a pop-up window or by asking the individual to upload his or her personal information. The personal information processing rules may include information such as the person who processes the personal information, the purpose of personal information processing, the method of processing, the types of personal information processed, etc.

Finally, it should be noted that the above-mentioned embodiments are only specific embodiments of the present disclosure, which are used to illustrate the technical solutions of the present disclosure and not to limit them, and the scope of protection of the present disclosure is not limited to this. Although the present disclosure is described in detail with reference to the aforesaid embodiments, a person skilled in the art should understand that any person skilled in the art who is familiar with the art can still modify the technical solutions described in the aforesaid embodiments or can easily think of changes within the scope of the technology disclosed in the disclosure, or the equivalent substitution of some of the technical features. These modifications, changes or substitutions do not depart the essence of the corresponding technical solutions from the spirit and scope of the technical solutions of the embodiments of the present disclosure, which shall be covered in the scope of protection of the present disclosure. Therefore, the scope of protection of the present disclosure shall be stated in accordance with the scope of protection of the claims.

1. A method for content generation, comprising:
acquiring input information to be answered;
according to a target scenario category to which the information to be answered belongs, acquiring model assistant information that matches the target scenario category, wherein the model assistant information comprises weight indicator information, and the weight indicator information is used for indicating corresponding generation weights under a plurality of generation angles when sequentially generating each character in answer content information; and
using an artificial intelligence model to generate target answer content information according to the information to be answered and the model assistant information.

2. The method according to claim 1, wherein the using an artificial intelligence model to generate target answer content information according to the information to be answered and the model assistant information, comprises:
using the artificial intelligence model to perform semantic recognition on the information to be answered to obtain semantic features;
according to the generation weights indicated by the weight indicator information in the model assistant information, determining target characters from characters to be generated under each of the generation angles, wherein the characters to be generated match the semantic features; and
obtaining the target answer content information based on each of the target characters sequentially determined.

3. The method according to claim 1, wherein the using an artificial intelligence model to generate target answer content information according to the information to be answered and the model assistant information, comprises:
using the artificial intelligence model to perform semantic recognition on the information to be answered to obtain semantic features; and
according to the semantic features and the generation weights indicated by the weight indicator information, generating the target answer content information based on generation theme configuration information and model constraint information comprised in the model assistant information, wherein the generation theme configuration information comprises a task theme corresponding to the artificial intelligence model and/or prompt information for guiding information input, and the generation theme configuration information is further used to be sent to a client for display.

4. The method according to claim 3, wherein the according to the semantic features and the generation weights indicated by the weight indicator information, generating the target answer content information based on generation theme configuration information and model constraint information comprised in the model assistant information, comprises:
determining a total quantity of historical tokens according to a quantity of dialogue tokens corresponding to each round of historical dialogue, wherein the dialogue tokens are determined according to text in historical information to be answered and text in historical answer content information comprised in the historical dialogue, and a round of the historical dialogue corresponds to a plurality of the dialogue tokens; and
in response to the total quantity of the historical tokens being less than a preset quantity, according to the semantic features and the generation weights, generating the target answer content information based on the generation theme configuration information and the model constraint information.

5. The method according to claim 3, wherein the model constraint information is set according to following steps:
setting task theme configuration information and generation rule information according to a content generation theme of the artificial intelligence model;
setting sample data related to the content generation theme to cause the artificial intelligence model to learn data feature information corresponding to the sample data;
setting result format configuration information according to a content format of an answer content to be generated; and
obtaining the model constraint information according to the task theme configuration information, the generation rule information, the sample data and the result format configuration information.

6. The method according to claim 1, further comprising:
according to the information to be answered, the generation weights, historical information to be answered and historical answer content information, using the artificial intelligence model to generate recommended dialogue information.

7. The method according to claim 1, wherein after the generating target answer content information, the method further comprises:
adjusting the weight indicator information according to a first correlation degree between newly acquired information to be answered and the target answer content information, a first repetition degree between the information to be answered and the newly acquired information to be answered, and second correlation degrees and second repetition degrees corresponding to a plurality of rounds of historical dialogue,
wherein the second correlation degree corresponding to each round of the historical dialogue is used for indicating a correlation degree between historical answer content information in a current round of the historical dialogue and historical information to be answered in a next round of the historical dialogue, and the second repetition degree corresponding to each round of the historical dialogue is used for indicating a repetition degree between historical information to be answered in the current round of the historical dialogue and historical information to be answered in a previous round of the historical dialogue.

8. A computer device, comprising:
at least one processor and at least one memory,
wherein the memory stores machine-readable instructions that are executable by the processor, the processor is configured for executing the machine-readable instructions stored in the memory, and when the machine-readable instructions are executed by the processor, the processor executes steps of a method for content generation, the method includes:
acquiring input information to be answered;
according to a target scenario category to which the information to be answered belongs, acquiring model assistant information that matches the target scenario category, wherein the model assistant information comprises weight indicator information, and the weight indicator information is used for indicating corresponding generation weights under a plurality of generation angles when sequentially generating each character in answer content information; and
using an artificial intelligence model to generate target answer content information according to the information to be answered and the model assistant information.

9. The computer device according to claim 8, wherein the using an artificial intelligence model to generate target answer content information according to the information to be answered and the model assistant information, comprises:
using the artificial intelligence model to perform semantic recognition on the information to be answered to obtain semantic features;
according to the generation weights indicated by the weight indicator information in the model assistant information, determining target characters from characters to be generated under each of the generation angles, wherein the characters to be generated match the semantic features; and
obtaining the target answer content information based on each of the target characters sequentially determined.

10. The computer device according to claim 8, wherein the using an artificial intelligence model to generate target answer content information according to the information to be answered and the model assistant information, comprises:
using the artificial intelligence model to perform semantic recognition on the information to be answered to obtain semantic features; and
according to the semantic features and the generation weights indicated by the weight indicator information, generating the target answer content information based on generation theme configuration information and model constraint information comprised in the model assistant information, wherein the generation theme configuration information comprises a task theme corresponding to the artificial intelligence model and/or prompt information for guiding information input, and the generation theme configuration information is further used to be sent to a client for display.

11. The computer device according to claim 10, wherein the according to the semantic features and the generation weights indicated by the weight indicator information, generating the target answer content information based on generation theme configuration information and model constraint information comprised in the model assistant information, comprises:
determining a total quantity of historical tokens according to a quantity of dialogue tokens corresponding to each round of historical dialogue, wherein the dialogue tokens are determined according to text in historical information to be answered and text in historical answer content information comprised in the historical dialogue, and a round of the historical dialogue corresponds to a plurality of the dialogue tokens; and
in response to the total quantity of the historical tokens being less than a preset quantity, according to the semantic features and the generation weights, generating the target answer content information based on the generation theme configuration information and the model constraint information.

12. The computer device according to claim 10, wherein the model constraint information is set according to following steps:
setting task theme configuration information and generation rule information according to a content generation theme of the artificial intelligence model;
setting sample data related to the content generation theme to cause the artificial intelligence model to learn data feature information corresponding to the sample data;
setting result format configuration information according to a content format of an answer content to be generated; and
obtaining the model constraint information according to the task theme configuration information, the generation rule information, the sample data and the result format configuration information.

13. The computer device according to claim 8, further comprising:
according to the information to be answered, the generation weights, historical information to be answered and historical answer content information, using the artificial intelligence model to generate recommended dialogue information.

14. The computer device according to claim 8, wherein after the generating target answer content information, the method further comprises:
adjusting the weight indicator information according to a first correlation degree between newly acquired information to be answered and the target answer content information, a first repetition degree between the information to be answered and the newly acquired information to be answered, and second correlation degrees and second repetition degrees corresponding to a plurality of rounds of historical dialogue;
wherein the second correlation degree corresponding to each round of the historical dialogue is used for indicating a correlation degree between historical answer content information in a current round of the historical dialogue and historical information to be answered in a next round of the historical dialogue, and the second repetition degree corresponding to each round of the historical dialogue is used for indicating a repetition degree between historical information to be answered in the current round of the historical dialogue and historical information to be answered in a previous round of the historical dialogue.

15. A non-transient computer-readable storage medium, wherein a computer program is stored on the non-transient computer-readable storage medium, and when the computer program is run by a computer device, the computer device executes steps of a method for content generation, the method includes:
acquiring input information to be answered;
according to a target scenario category to which the information to be answered belongs, acquiring model assistant information that matches the target scenario category, wherein the model assistant information comprises weight indicator information, and the weight indicator information is used for indicating corresponding generation weights under a plurality of generation angles when sequentially generating each character in answer content information; and
using an artificial intelligence model to generate target answer content information according to the information to be answered and the model assistant information.

16. The non-transient computer-readable storage medium according to claim 15, wherein the using an artificial intelligence model to generate target answer content information according to the information to be answered and the model assistant information, comprises:
using the artificial intelligence model to perform semantic recognition on the information to be answered to obtain semantic features;
according to the generation weights indicated by the weight indicator information in the model assistant information, determining target characters from characters to be generated under each of the generation angles, wherein the characters to be generated match with the semantic features; and
obtaining the target answer content information based on each of the target characters sequentially determined.

17. The non-transient computer-readable storage medium according to claim 15, wherein the using an artificial intelligence model to generate target answer content information according to the information to be answered and the model assistant information, comprises:
using the artificial intelligence model to perform semantic recognition on the information to be answered to obtain semantic features; and
according to the semantic features and the generation weights indicated by the weight indicator information, generating the target answer content information based on generation theme configuration information and model constraint information comprised in the model assistant information, wherein the generation theme configuration information comprises a task theme corresponding to the artificial intelligence model and/or prompt information for guiding information input, and the generation theme configuration information is further used to be sent to a client for display.

18. The non-transient computer-readable storage medium according to claim 17, wherein the according to the semantic features and the generation weights indicated by the weight indicator information, generating the target answer content information based on generation theme configuration information and model constraint information comprised in the model assistant information, comprises:
determining a total quantity of historical tokens according to a quantity of dialogue tokens corresponding to each round of historical dialogue, wherein the dialogue tokens are determined according to text in historical information to be answered and text in historical answer content information comprised in the historical dialogue, and a round of the historical dialogue corresponds to a plurality of the dialogue tokens; and
in response to the total quantity of the historical tokens being less than a preset quantity, according to the semantic features and the generation weights, generating the target answer content information based on the generation theme configuration information and the model constraint information.

19. The non-transient computer-readable storage medium according to claim 17, wherein the model constraint information is set according to following steps:
setting task theme configuration information and generation rule information according to a content generation theme of the artificial intelligence model;
setting sample data related to the content generation theme to cause the artificial intelligence model to learn data feature information corresponding to the sample data;
setting result format configuration information according to a content format of an answer content to be generated; and
obtaining the model constraint information according to the task theme configuration information, the generation rule information, the sample data and the result format configuration information.

20. The non-transient computer-readable storage medium according to claim 15 further comprising:
according to the information to be answered, the generation weights, historical information to be answered and historical answer content information, using the artificial intelligence model to generate recommended dialogue information.
